(19) United States
(12) Patent Application Publication
(10) Pub. No.: US 2017/0253300 A1
(43) Pub. Date: Sep. 7, 2017

(54) Paravane for a Floating Barrier

(71) Applicant: DESMI Ro-Clean A/S, Odense S (DK)

(72) Inventor: Lars Boldt Rasmussen, Otterup (DK)

(73) Assignee: DESMI Ro-Clean A/S, Odense S (DK)

(21) Appl. No.: 15/506,763

(22) PCT Filed: Aug. 25, 2015
(86) PCT No.: PCT/DK2015/050248

§ 371 Date: Feb. 27, 2017

(30) Foreign Application Priority Data
Aug. 27, 2014 (DK) PA 2014 00477

(51) Int. Cl. B63B 21/66

(52) U.S. Cl. CPC B63B 21/66; A01K 73/045

(57) ABSTRACT

Paravane for floating barrier A paravane (20) including at least one foil with a first side, a second side, a leading end, a trailing end, a top and a bottom, wherein at least one foil is straight (1) and at least one second foil is curved (2), where one side of the straight foil and the other side of the curving foil are interconnected by a number of stays (3), where at least one foil is connected at the top to at least a first buoyant body (10) and that at least the one plane at the bottom is connected to at least one ballast element (13), and that at the second side of the straight foil there are at least one towline (8) and a tow eye (9) by which there is achieved a paravane (20) that can keep an arrangement of lines, nets, floats in a water body in a position suitable for performing the task.

### FIELD OF THE INVENTION

The present invention concerns a paravane for use in towing e.g. floating barriers, including at least one foil with a first side, a second side, a leading end, a trailing end, a top and a bottom.

### BACKGROUND OF THE INVENTION

The paravane described by the present invention is particularly directed towards use with floating barriers which e.g. are used for encircling oil spilled at sea or on other water surfaces. A particular application of floating barriers is to perform a sweep operation by which a floating barrier is kept extended in V formation and is moved through the water surface towards the oil spill. The oil can thus be concentrated at the rear end of the sweep and afterwards be collected by pumps or skimmers.

A prior art technology for this purpose can be use of two forward going boats between which the sweep is kept appropriately extended. Another prior art technology is the use of a strong jib arm or boom by which one side of the “sweep” is secured to the ship's side and the other side is kept away by the jib arm. A third prior art technology is the use of a paravane where one side is secured to the ship's side and the other side is held out by means of the hydraulic forces produced by the paravane in the water. The same principle known from trawl doors. This principle is described used on floating barriers in U.S. Pat. No. 6,488,445 B1 where, however, the focus is particularly on the corresponding use of the paravane for retaining floating barriers in a strong current, like a river.

WO 2009075961 A1 discloses a method and apparatus for evaluation of, for example, geological formations under water, where several hydrofoils provide controllable separation for multiple receivers, as they are towed through water, but where the hydrofoils are closed units.

The present invention differs from the prior art technology by being made of flexible materials, such as plastic membrane, rubber-coated cloth or canvas. In addition, the invention differs by utilising aerodynamic principles known from airfoils, modern parachutes and kites used for windsurfing.

The advantage of using flexible materials is particularly that the paravane can be packed together and stored in very little space. Prior art paravanes for use with floating barriers or in seismic surveys are characterised by being very voluminous and vulnerable to mechanical actions. They frequently require crane equipment for handling.

The advantage of transferring aerodynamic principles to application in a water body is that the towing force of a paravane can be markedly more efficient such that it can be produced with the least possible area and volume.

### OBJECT OF THE INVENTION

The invention includes a paravane for use in towing e.g. floating barriers in formation in connection with collecting oil on large water surfaces. The invention may also find application in connection with trawl fishing and seismic surveys where trawl doors or paravanes are traditionally used. In any case, the purpose of using paravanes is to hold an arrangement of lines, nets, floats in a water body in a position suitable for performing the task. This is done with the use of only one ship. The present invention is peculiar in that the paravane is made of flexible material and by utilising principles from airborne devices, such as kites and parachutes.

The object of the present invention is to increase the efficiency of the use of the sweep system in connection with collecting oil on open water surfaces and e.g. in rapidly flowing rivers. The increased efficiency and cost saving by only having to use one ship is known, but the advantage of the present invention is that it can be used with a much wider range of ships which do not need special adaptation due to the compact design of the present paravane. Another object is to produce a product which is very little sensitive to mechanical actions that often occur in stormy seas. A third object is to provide a paravane which due to the compactness is very easy to transport by air, which is often of importance in connection with controlling oil spills.

### DESCRIPTION OF THE INVENTION

The present invention consists of a profile resembling an airfoil which is kept vertically in the water by means of ballast and a buoyant body. The buoyancy is adapted such that the profile is kept just floating at the water surface in vertical position.

Corresponding profiles are known from trawl doors which, however, are characterised by being non-floating (U.S. Pat. No. 4,180,935) and by a rigid self-supporting construction, usually made of steel.

By the present invention, the airfoil profile is created by letting water pressure distend a flexible object such that hereby an air foil is achieved. The water pressure arises by forward movement of the profile which has a very open leading edge and a less open trailing edge. This corresponds to a modern so-called ram-air parachute which by the air filling its air ducts attains an airfoil and produces lift. In this type of parachute, the correct spatial geometry is ensured by establishing a number of bulkheads between the top and bottom sides of the foil. These bulkheads are in principle comparable to ribs in an aeroplane wing but made of a thin fabric material.

By the present invention, these bulkheads can also be made of a flexible, fabric-like material, but may as well consist of a number of stays, possibly made of thin steel wires.

By an embodiment like the ram-air parachute, the profile geometry is also supported by a large number of lines with precisely matched lengths. This is less suitable by the application of the invention where a few towlines are to be preferred. The geometry in the flexible material is therefore supported by a number of inserted struts, comparable to sail battens. On the inlet side of the profile these are laid horizontally such that the curvature in horizontal plane is minimised. On the opposite side of the profile they are set vertically such that this side can curve in a controlled way in horizontal direction. In order to keep the whole system extended there is also on the inlet side provided one or more vertically draw bars to which the towlines of the paravane can be fastened.

The directional rigidity can also be achieved in other ways, such as hinging together of narrow lamellae, use of transversely stiffened, reinforced tarpaulins or hard-pumped water or air ducts.

In order to achieve ample lift by an airfoil or, as in the present invention, horizontal pull in a paravane, two conditions are to be fulfilled. The airfoil is to encounter the water flow at an optimal angle - the angle of attack, and the top side of the profile is to have an optimal camber. Crucial for the attainable pull force is also how large the area of the profile is. This is expressed as chord and span, respectively. The chord is from leading edge of the profile to trailing edge in the direction of flow. Span is the length at right angles thereto.

The camber of the airfoil can, as described, be controlled by inserted bulkheads or stays. In the embodiment chosen here, stays are inserted in order to achieve the greatest possible compactness when the paravane is not in operation and is to be stored. The stays are provided at one end with a locking eye which easily can be released or assembled. Thus it is possible in a short time to separate or assemble the two sides of the profile. After separation, respective front and rear sides can be rolled together opposite the direction of the sail battens and stored as two separate cylinders with least possible volume.

The buoyant body can be designed as a long inflatable air chamber or possibly as loose floats that are attached during preparation.

The ballast can be constituted weight blocks or chains disposed along the lower edge of the paravane or which are fastened during preparation and putting out.

An embodiment of the paravane is constituted in that the curving side, opposite the inlet side, is doubled either across the entire chord length of the paravane or in a part thereof. This extra foil is held in a suitable aerodynamic geometry corresponding to the first foil by means of an appropriate number of stays. Corresponding systems are known from trawl doors, though not made of a flexible material held extended by the water pressure; U.S. Pat. No. 3,299,560, US 2012/0174464 A1.

An embodiment of the paravane is constituted by the trailing edge of the paravane in the flow direction not being open, but openings are made instead, possibly circular, rearmost of the curving side (lee side) through which water can be pressed out.

An embodiment of the paravane is constituted in that buoyancy and ballast elements are mounted detachable such that they can be exchanged. This means that the paravane can be reconfigured in a simple way from starboard to port operation.

An embodiment of the paravane is constituted by the through-flow opening from top to bottom varying in that the stays are differentiated in length in vertical direction, thereby providing vertically angled foils. This is for achieving a downward or upward pulling force in the paravane.

An embodiment of the paravane is constituted by the reinforcing ducts being provided with stiffeners (sail battens) that are easily removable. This is for facilitating the packing operation and for reducing the need for storage space.

An embodiment of the paravane is constituted by the length of the stays being adjustable manually or automatically in a simple way. This is provided for adapting the camber of the paravane to varying operational speed or power demand.

An embodiment of the paravane is constituted by being provided along its trailing edge with a hinge mechanism that enables coupling together with the towed object, e.g. a floating barrier.

An embodiment of the paravane is constituted by being an integrated part of the towed object itself, e.g. a floating barrier.

An embodiment of the paravane is constituted in that the flexible material constituting the foils of the paravane is made of a fabric- or metal-reinforced rubber construction which is assembled by a vulcanising technique and mechanical joints.

An embodiment of the paravane is constituted in that the flexible material constituting the foils of the paravane is made of a fabric-reinforced thermoplastic material which is assembled by welding or sewing and mechanical joints.

A paravane for controlling a float barrier formation in an oil collecting operation and to which is required more than one towing unit, possibly ships, where the paravane is made of a flexible material like rubber or thermoplastic, and which due to this fact can be collapsed and packed into a very small volume when not in use, and consequently is very robust to blows and impacts as well.

The paravane is based on aerodynamic principles known from airborne devices like parachutes and kites.

The paravane is kept floating in the water surface by means of an inflatable or permanent buoyant body.

The paravane is held vertical in the water column by means of ballast elements along the bottom edge of the construction.

The flexible foils of the paravane are held straight or curved by means of inserted struts in cavities of the flexible materials.

The paravane contains one or more foils of which at least one has a curved, airfoil-like profile.

Two or more foils of the paravane are fixed spaced apart by means of stays in the form of e.g. steel wires or by means of bulkheads that can be made of flexible material.

The paravane has stays or bulkheads inserted between foils of the paravane which can be manually or automatically adjustable such that two interconnected foils can be adjusted in mutual distance and geometry.

The paravane is provided with the outlet opening along the trailing edge of the paravane which may be constituted by openings in the rearmost foil of the paravane.

The paravane is integrated into a towing end of a floating barrier which is an integrated part thereof.

### LIST OF FIGURES

The invention is explained more closely in the following with reference to the drawing, where:

FIG. 1 shows a horizontal section of the paravane according to the invention with mounted towlines;

FIG. 2 shows a horizontal section of the paravane according to the invention with buoyancy chamber and double buoyant foil (biplane);

FIG. 3 is a perspective view of an embodiment of the paravane where the rearmost opening is provided as circular openings along the trailing edge of the rearmost foil;

FIG. 4 is a perspective view of a paravane mounted with towlines and assembly fittings;

FIG. 5 shows an operative formation with deployed paravane for controlling a floating barrier formation.

In the explanation of the Figures, identical or corresponding elements are described with the same designations in different Figures. Any complete explanation of these in each single drawing will therefore not be given.

### LIST OF DESIGNATIONS

1 straight front foil

2 curving rear foil

3 stay

4 vertical struts

5 horizontal struts

6 open front end

7 open rear end

8 towline

9 tow eye

10 buoyant element

11 openings

12 towline to vessel

13 ballast element

14 floating barrier formation

15 towline

16 spacer line

17 secondary towline

18 primary towline

19 oil control vessel

20 paravane

### Detailed Description of Embodiments of the Invention

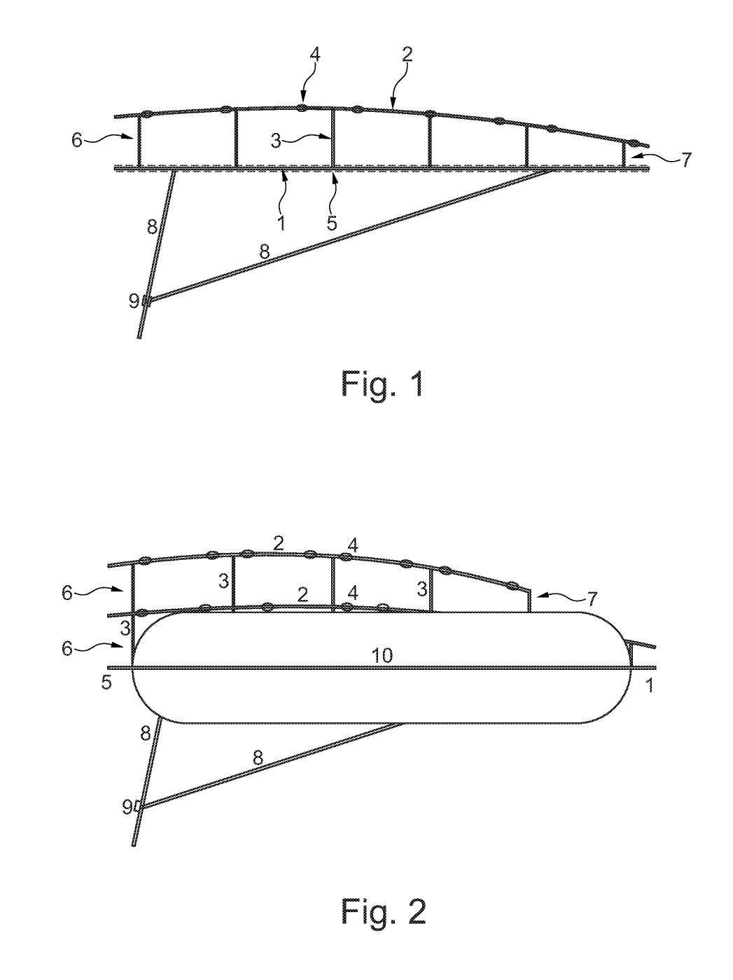

In FIG. 1 is shown a paravane according to the invention in a horizontal section, consisting of a straight front foil 1 and a curving rear foil 2 made of a flexible material. Between the two foils are shown stays 3 that fix the distance between the two foils. 6 and 7 show the very open front end and the less open rear end, respectively. Vertical struts 4 are inserted in the curving rear foil 2. Horizontal struts 5 are inserted in the straight front foil. Towlines 8 are joined in a common tow eye 9.

In FIG. 2 is shown a paravane according to the invention in a horizontal section, consisting of a straight front foil 1 and two curving rear foils 2. In line with the front foil is shown a buoyant element 10 which can be inflatable or solid.

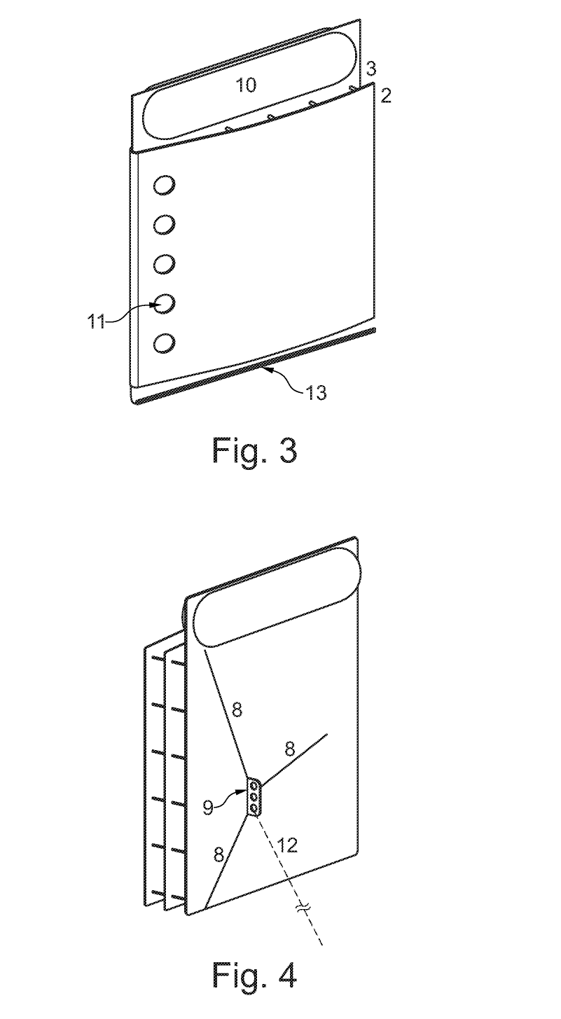

In FIG. 3 appears an embodiment of the paravane in perspective view where the rearmost opening 7 is substituted by a number of circular openings in the trailing edge of the curving rear foil 2. The buoyant element 10 is shown disposed uppermost on the straight front foil 1 and ballast elements 13 are shown along the lower edge of the straight front foil 1.

In FIG. 4 is shown an embodiment of the paravane in perspective view where three towlines 8 are joined in a common tow fitting 9 from where the towing force can be transmitted to the towed object through the towline 12.

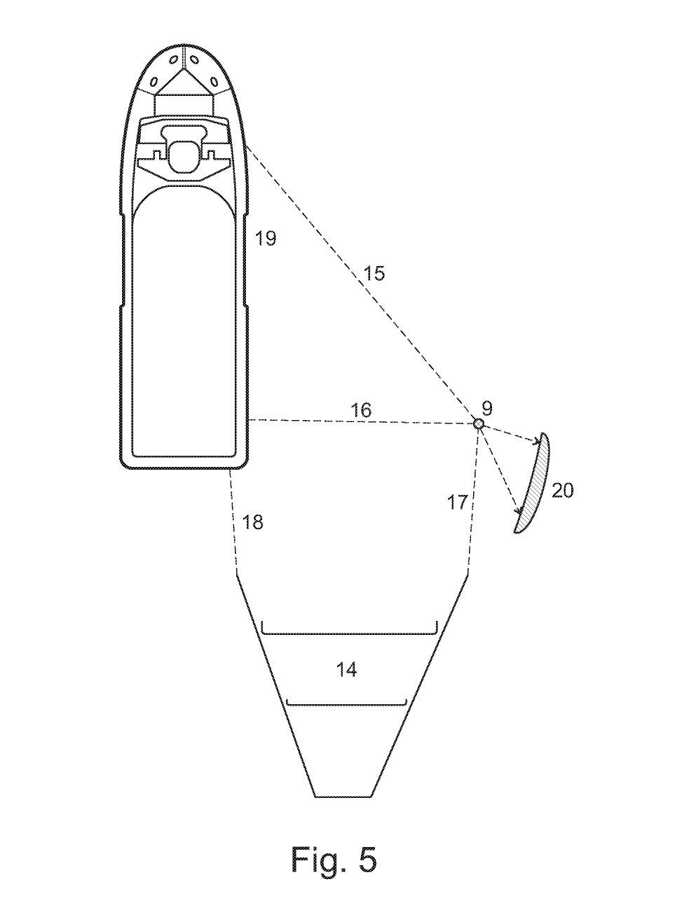

In FIG. 5 is shown a formation where the paravane according to the invention is deployed as towing element for controlling a floating barrier formation. 14 shows a floating barrier in the form of a V-shaped sweep system 14. An oil control vessel 19. Primary towline for floating barrier formation 18. Secondary towline 17 connected to the tow fitting 9 of the paravane. Towline 15 transmitting the forward movement of the oil control vessel to the paravane. Spacer line 16 controlling the degree of opening of the floating barrier formation.

1. A paravane (20) for use in towing e.g. floating barriers, including at least one foil with a first side, a second side, a leading end, a trailing end, a top and a bottom, where at least one foil is straight (1) and at least one other foil is curved (2), where one side of the straight foil and the other side of the curving foil are interconnected, wherein one side of the straight foil and the other side of the curving foil are interconnected by a number of struts (3), wherein at least one foil is connected at the top to at least a first buoyant body (10) and that at least one foil is connected at the bottom to at least one ballast element (13), and that at the second side of the straight foil there are at least one towline (8) and a tow eye (9), wherein the at least one straight foil and the at least one curved foil and at least a number of stays are made of flexible, collapsible materials.

2. (canceled)

3. Paravane according to claim 1, wherein the at least one straight foil and the at least one curved foil include cavities for struts.

4. Paravane according to claim 1, wherein the at least one straight foil includes struts that are substantially parallel with top/bottom and with a longitudinal axis in direction leading end/trailing end.

5. Paravane according to claim 1, wherein the at least one curved foil includes struts that are substantially parallel with leading end/trailing end and with a longitudinal axis in direction top/bottom.

6. Paravane according to claim 1, wherein the stays are axially shaped, e.g. in the form of steel wires, and/or flatly formed, e.g. in the form of bulkheads.

7. Paravane according to claim 1, wherein the stays are manually or automatically adjustable.

8. Paravane according to claim 1, wherein at least the first buoyant body is inflatable or permanent, and that possible additional buoyant bodies are inflatable or permanent.

9. Paravane according to claim 1, wherein the at least one straight foil and the at least one curved foil include trailing ends that meet entirely or partially, and that the at least one straight foil and/or the at least one curved foil include at least one outflow opening at the rearmost part of the foil.

10. Paravane according to claim 1, wherein the paravane (20) is integrated in the towing end of a floating barrier.
